(19) United States
(12) Patent Application Publication
(10) Pub. No.: US 2012/0179632 A1
(43) Pub. Date: Jul. 12, 2012

(54) Core Storage and Management System

(76) Inventors: Daniel J. Pienta, Lambertville, MI (US); David M. Pienta, Lambertville, MI (US)

(21) Appl. No.: 13/344,005

(22) Filed: Jan. 5, 2012

Related U.S. Application Data
(60) Provisional application No. 61/460,826, filed on Jan. 7, 2011.

(51) Int. Cl. B65G 47/74; G06Q 90/00

(52) U.S. Cl. 705/500; 414/222.01; 414/806

(57) ABSTRACT

A system and method for receiving, handling and storing used rolls following unwinding of sheet material therefrom includes:

(a) transferring the cores to a remnant cleaning station,

(b) inspecting for (i) remnant material, (ii) repairable damage or (iii) irreparable damage; and

(c) for those cores cleaned, repaired, or satisfactory as is, transferring them to a storage rack for the specific size and length.

### CROSS REFERENCE TO RELATED APPLICATION

This application is based upon and claims the benefit of U.S. Provisional Patent Application No. 61/460,826 filed Jan. 7, 2011.

### TECHNICAL FIELD

The present invention relates generally to a system for storing and managing the cores of rolls of sheet form material. After the sheet form material is unwound from the core, the core is transferred to the core storage and management system for further processing. The present invention is related to our co-pending application Ser. No. 12/928,231 for an Automatic Core Cleaning Apparatus and co-pending application Ser. No. 12/925,084 for an Automatic Core Joining and Cutting Apparatus. The present invention may be used independently of or variously in combination with the technology disclosed and claimed in the related applications. The co-pending applications are incorporated herein by reference.

### SUMMARY OF THE INVENTION

The present invention is a highly adaptable core storage and management system that can be adapted for use in any industrial setting where sheet form material is provided on large rolls having cores. After the sheet form material is dispensed from the rolls during the manufacturing process, the core remains, usually having some remnants of sheet form material still attached. The core is cleaned, inspected and either stored for reuse, repaired and stored for reuse, or disposed of. The core storage and management system of the present invention is intended to accumulate the spent cores, clean cores, and rejected cores for either reuse or disposal. The core storage and management system will monitor the lengths and diameters of the cores and sort the cores of various sizes into storage racks designated for each core of various sizes. The storage and management system of the present invention can be designed for use in conjunction with a core cutting and joining apparatus such as that disclosed in our co-pending U.S. patent application Ser. No. 12/925,084. The core storage and management system of this invention can also be used in combination with a core cleaning apparatus as disclosed in our co-pending U.S. patent application Ser. No. 12/928,231.

Ideally, the core storage and management system of the present invention will identify clean cores of various sizes and diameters and store the clean cores in specified racks.

The core storage and management system is extremely adaptable in that it can utilize any number of storage racks and the storage racks can be adaptable to contain stacks of individual cores or cores of various lengths and diameters.

Cameras can be used to inspect incoming cores to see if they are clean or damaged. The core storage and management system of this invention includes an inspection station for the manual inspection of cores for damage. Any damaged cores can either be sent to a core cutter and joiner machine located proximate the core storage and management system, or disposed of if damaged too badly for repair.

The core storage and management system uses sensor arrays to monitor the length and diameter of each core member it receives. The core storage and management system maintains a record of the total number of each core size received and interfaces with the manufacturing processes to ensure that cores of proper diameter and length are being delivered to the proper cleaning and repair stages within the facility.

RFID tags are affixed to each core except for those damaged too badly for repair. The RFID tags contain information regarding the size and condition of each core (i.e. whether acceptable for re-use as is, in need of cleaning, in need of repair), and storage location.

The core storage and management system is used at facilities that convert product on cores and provides for reuse of the cores. The core storage and management system stores cores, identifies core lengths and diameters, identifies cores that are damaged and can be salvaged via a core cutting and joining apparatus, manages inventory, processes outbound orders by either utilizing existing inventory or creating the cores via the core cutter and joiner apparatus. The core storage and management system significantly reduces manpower and safety issues.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a top view of a core storage system as used with the present invention.

FIG. 2 is a top view of the core storage unit of the system of FIG. 1.

FIG. 3 is a side view of the core storage unit of FIG. 2.

FIG. 4 is an end view of the core storage unit of FIG. 2.

### DETAILED DESCRIPTION OF THE INVENTION

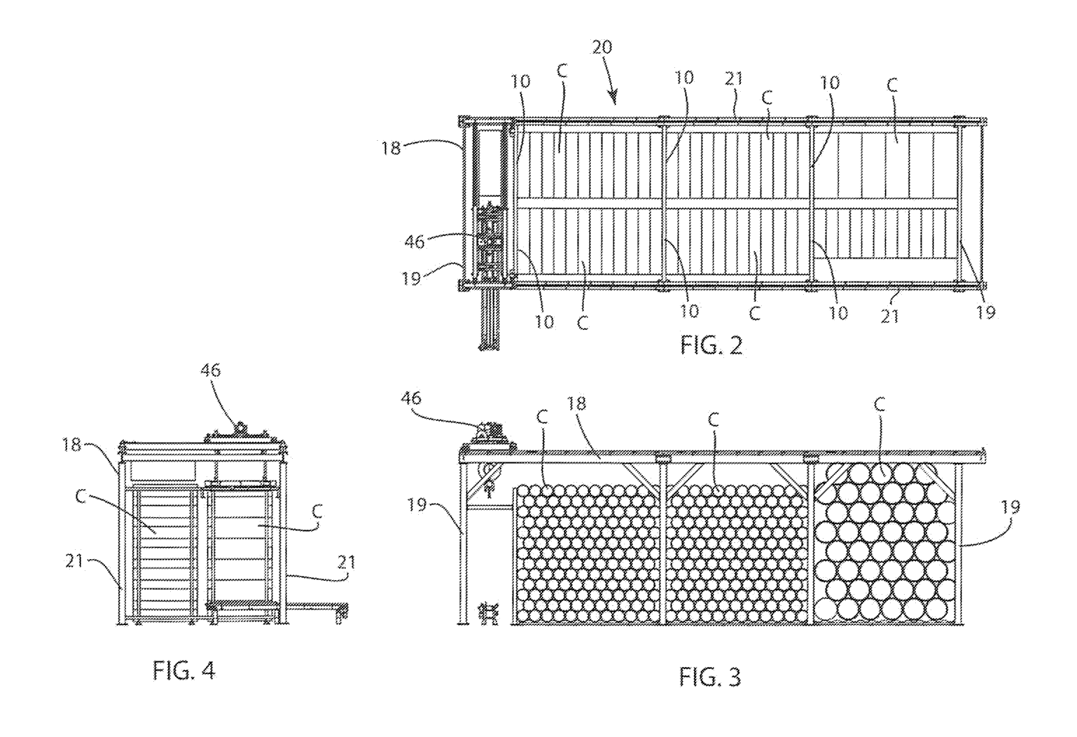

The core storage unit section of the management system of the present invention is shown in FIGS. 2-4 as a simple layout. The core storage unit section 20 comprises six racks 10 for storing cores C. The number, size and layout of racks 10 in the storage unit can vary depending on the requirements of the manufacturing facility. The racks 10 are designed to inventory and store cores C of either the same size or of varying sizes (as shown in FIGS. 2-4) and lengths (as shown in FIG. 2). The storage system includes an overhead crane 46 for receiving and delivering clean cores to the appropriate rack 10 for the specific size and length of core C being conveyed. The overhead crane 46 rides across the top of frame 18 to deliver a received core to its appropriate rack or to remove a core for delivery from its appropriate rack 10. The frame 18 extends longitudinally between ends 19 and laterally between sides 21. The crane 46 is mounted for movement both longitudinally and laterally in order to place core C in the appropriate rack 10 for its size (diameter) and length. The crane 46 has clamps 48 actuatable between a closed position for gripping the cores and an open position for releasing the cores C.

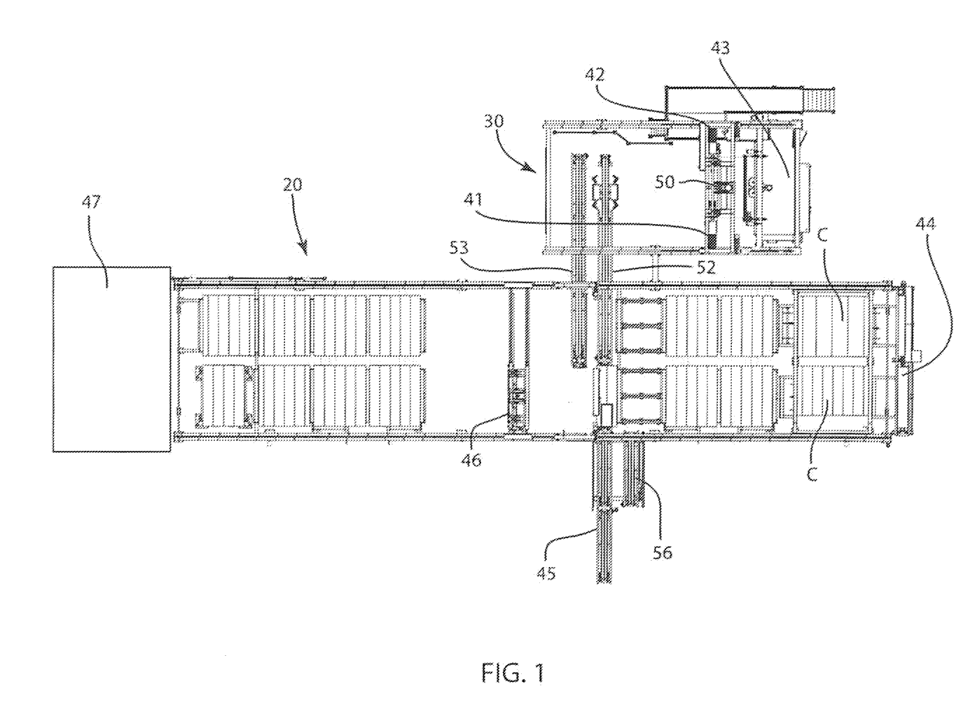

Referring now to FIG. 1, the core storage management system includes the core storage unit section 20 and an inspection/cleaning section 30. The core storage unit section 20 extends longitudinally between a core joiner station 47 (for example of the type disclosed in application Ser. No. 12/925,084) and a manual inspection station 44. The core joiner station 47 is not necessarily part of the system of the present invention. It could be located at a position remote from the system. The inspection/cleaning station 30 is adjacent to the core storage unit section 20 and is positioned to receive incoming cores C via a cross conveyor 52 extending there between. A loading conveyor 45 receives cores C and moves them laterally onto the core storage unit section 20 and then to the cross conveyor 52 and onto the inspection/cleaning station 30. The inspection/cleaning station 30 includes core cleaning assembly 43 that cuts any remnant material from the used core C. The remnant material is transferred to a final destination, for example a pulper, bailer, or other processing unit. After the core C is cleaned it is then inspected to determine whether it is damaged or whether it is acceptable for reuse.

The inspection station includes at least one camera 41 positioned to inspect the core C. The camera 41 is preferably movable such that it can inspect both ends of the core C. In other embodiments, a second camera 42 may be included at the inspection station 30. If the core C is clean, it is delivered to a second cross conveyor 53 for return to the core storage unit section 20. An overhead crane 46 picks up the clean core and transports it to its proper rack 10 for storage. If the core C fails inspection, it is sent to a manual inspection station 44 for operator intervention.

Adjacent to and parallel with the loading conveyor 45 is an unloading conveyor 56. The loading conveyor 45 and unloading conveyor 56 are mounted on mechanism which is moveable longitudinally. Such longitudinal movement moves the two conveyor 45, 56 from a first longitudinal position at which the loading conveyor 45 is aligned with the first cross conveyor 52 for delivery of cores C thereto to a second position at which the unloading conveyor 56 is aligned with the first cross conveyor 52 so that it can receive cores C being removed from the core management system. However, the position and layout of the various units of the core storage management system 10 (i.e. core storage unit section 20, racks 10, core cleaning assembly 43, inspection station 30 and conveyors) may vary. Accordingly, the method of moving the cores may vary from site to site.

The storage racks 10 can variously contain individual used and clean cores. The clean cores C can be retrieved from the appropriate storage racks 10 for delivery to the unloading conveyor 56.

The core storage and management system further includes an inspection station 44 wherein each core can be delivered for manual inspection. If any of the cores are damaged, but salvageable, they can be delivered by crane 46 to the adjacent core cutter and joiner apparatus 47. A properly joined core can then delivered by overhead crane 46 to its appropriate storage rack 10.

It should be noted that the layout of the various components is not necessarily as shown in FIG. 1. The components can be used in a variety of combinations and locations depending on the requirements and layout of the facility in which it is used.

This description of the core storage and management system is intended to be illustrative. As explained herein the system is extremely adaptable for use in a variety of manufacturing settings. The scope of the present invention is set forth in the appended claims.

We claim:

1. A system for handling used cores of rolls of sheet material following unwinding of said sheet material comprising:
(a) a frame having a pair of spaced apart ends and a pair of spaced apart sides;
(b) a crane supported on said frame for moving said cores;
(c) a power unit for moving said crane (i) toward and away from said ends and (ii) toward and away from said sides;
(d) a plurality of storage racks in said frame for storing unwound cores;
(e) a cleaning assembly for removing remnant material from unwound cores;
(f) an inspection station for visually or photographically inspecting each unwound core to determine if it is reusable or damaged.

2. The system of claim 1 further including a repair station for repairing damaged cores.

3. The system of claim 1 further including a control unit for directing transfer of said cores by said crane.

4. A method for handling used cores of rolls of sheet material following unwinding of said sheet material comprising the steps of
(a) cleaning remnant material from said cores;
(b) inspecting each unwound core for
(1) any remaining remnant material,
(2) repairable damage and
(3) irrepairable damage; and
(c) transferring said cores
(1) if clean of remnant material and undamaged, to a storage rack,
(2) if containing remnant material but undamaged, to a cleaner for further removal of the remnant material,
(3) if repairably damaged, to a rack to prepare for repair, and
(4) if irrepairably damaged, to scrap.

5. The method according to claim 4 further including the steps of
(d) providing a multiplicity of storage racks,
(e) measuring at least the diameter or the length of said cores and, thereafter,
(f) transferring said cores to a storage rack for cores of the same diameter and length.

6. The method according to claim 5 further including the steps of
(g) maintaining an inventory of the number of cores transferred to each said storage rack.

7. The method according to claim 4 further including the steps of removing remnant material from cores containing remnant material and transferring said removed remnant material for processing or disposal.

8. A method for handling used cores of rolls of sheet material following unwinding of said sheet material comprising the steps of
(a) providing a plurality of storage racks,
(b) measuring at least the diameter or length of each unwound core,
(c) cleaning remnant material from said core,
(d) inspecting each unwound core for
(1) remnant material,
(2) repairable damage, and
(3) irrepairable damage;
(e) transferring said cores
(1) if clean of remnant material and undamaged to a storage rack for that size core,
(2) if containing remnant material but undamaged, to a cleaner for removing said remnant material,
(3) if repairably damaged, to a rack to prepare for repair,
(4) if irrepairably damaged, to scrap.

9. The method according to claim 8 further including the steps of
(f) maintaining an inventory of the number of cores transferred to each said storage rack.

10. The method according to claim 8 further including the step of transferring said removed remnant material for disposal.
